(19) United States
(12) Patent Application Publication
(10) Pub. No.: US 2020/0404339 A1
(43) Pub. Date: Dec. 24, 2020

(54) LOOP FILTER APPARATUS AND METHOD FOR VIDEO CODING

(71) Applicant: Huawei Technologies Co., Ltd., Shenzhen (CN)

(72) Inventors: Roman Igorevich CHERNYAK, Moscow (RU); Victor Alexeevich STEPIN, Moscow (RU); Sergey Yurievich IKONIN, Moscow (RU); Shan GAO, Dongguan (CN); Huanbang CHEN, Shenzhen (CN); Haitao YANG, Shenzhen (CN); Jay SHINGALA, Bangalore (IN); Sriram SETHURAMAN, Bangalore (IN)

(21) Appl. No.: 17/013,232

(22) Filed: Sep. 4, 2020

Related U.S. Application Data
(63) Continuation of application No. PCT/RU2018/000144, filed on Mar. 7, 2018.

(51) Int. Cl. H04N 19/82; H04N 19/117; H04N 19/147; H04N 19/176; H04N 19/61; H04N 19/172; H04N 19/119

(52) U.S. Cl. CPC H04N 19/82; H04N 19/117; H04N 19/147; H04N 19/119; H04N 19/61; H04N 19/172; H04N 19/176

(57) ABSTRACT

The invention relates to a loop filter apparatus for processing a reconstructed picture of a video stream into a filtered reconstructed picture that includes a plurality of samples. The loop filter apparatus includes processing circuitry configured to apply a first partition to the reconstructed picture or at least a portion thereof so as to partition the reconstructed picture into a plurality of sample blocks and to apply a respective noise suppression filter to the one or more sample blocks to obtain one or more filtered sample blocks. The one or more sample blocks are defined by an application map, the noise suppression filter depends on the application map, and the application map partitions the reconstructed picture into a plurality of regions The processing circuitry is further configured to generate the filtered reconstructed picture. Moreover, the invention relates to a corresponding loop filtering method.

### CROSS-REFERENCE TO RELATED APPLICATIONS

This application is a continuation of International Application No. PCT/RU2018/000144, filed on Mar. 7, 2018. The disclosure of the aforementioned application is hereby incorporated by reference in its entirety.

### TECHNICAL FIELD

Generally, the present disclosure relates to the field of picture processing, in particular video picture coding. More specifically, the present disclosure relates to a method for filtering reconstructed video pictures, a loop filter apparatus, and an encoding apparatus and a decoding apparatus comprising such a loop filter apparatus.

### BACKGROUND

Video coding (video encoding and decoding) is used in a wide range of digital video applications, for example broadcast digital TV, video transmission over internet and mobile networks, real-time conversational applications such as video chat, video conferencing, DVD and Blu-ray discs, video content acquisition and editing systems, and camcorders of security applications.

Since the development of the block-based hybrid video coding approach in the H.261 standard in 1990, new video coding techniques and tools were developed and formed the basis for new video coding standards. One of the goals of most of the video coding standards was to achieve a bitrate reduction compared to its predecessor without sacrificing picture quality. Further video coding standards comprise MPEG-1 video, MPEG-2 video, ITU-T H.262/MPEG-2, ITU-T H.263, ITU-T H.264/MPEG-4, Part 10, Advanced Video Coding (AVC), ITU-T H.265, High Efficiency Video Coding (HEVC), and extensions, e.g. scalability and/or three-dimensional (3D) extensions, of these standards.

One tool implemented in many video coding standards is loop filtering for reducing coding artifacts, in particular noise.

### SUMMARY

The present disclosure provides for improving video coding efficiency by providing an improved loop filter apparatus and a method for noise suppression.

According to a first aspect, the relates to an in loop filter apparatus for processing a reconstructed picture (or a portion of a reconstructed picture) of a video stream into a filtered reconstructed picture (or a filtered portion of a filtered reconstructed picture), wherein the reconstructed picture comprises a plurality of samples, wherein each sample is associated with a sample value, such as an intensity value. The loop filter apparatus comprises processing circuitry configured to:
apply a first partition to the reconstructed picture (or the portion thereof) for partitioning the reconstructed picture (or the portion thereof) into a plurality of sample blocks;
filter one or more of the plurality of sample blocks (wherein “one or more of the plurality of sample blocks” includes or may include also “all sample blocks of the plurality of sample blocks” within this disclosure) by applying a respective noise suppression filter to the one or more of the plurality of sample blocks for obtaining one or more filtered sample blocks (or in other words: for obtaining filtered sample blocks for each of the one or more sample blocks), wherein the one or more of the plurality of sample blocks are defined by an application map, and wherein the noise suppression filter depends on, e.g. receives, the application map, wherein the application map partitions the reconstructed picture into a plurality of regions and defines for each region of the plurality of regions to use at least one of the one or more filtered sample blocks or one or more unfiltered sample blocks of the plurality of sample blocks from the respective region for generating the filtered reconstructed picture; and
generate the filtered reconstructed picture (or the filtered portion of the filtered reconstructed picture) on the basis of the one or more unfiltered sample blocks and the one or more filtered sample blocks.

Thus, an improved loop filter apparatus is provided that allows for reducing coding artifacts, in particular noise, thereby improving the efficiency for video coding.

In a further possible implementation form of the first aspect, the processing circuitry is configured to apply the noise suppression filter to a respective current sample block (herein also referred to as a “root block”) of the one or more sample blocks for obtaining the one or more filtered sample blocks by:
determining on the basis of a similarity measure one or more further sample blocks (herein also referred to as patches, non root blocks or matching blocks) similar to the respective current sample block for obtaining a respective stack, i.e. set of sample blocks, including the current sample block and the one or more further sample blocks;
collectively filtering the respective stack of sample blocks to obtain a respective filtered stack of sample blocks; and
generating the respective current filtered sample block on the basis of the one or more filtered stacks of sample blocks;
wherein the determination of the one or more further sample blocks similar to the respective current sample block and/or the collective filtering of the respective stack of sample blocks depends on the application map.

In a further possible implementation form of the first aspect, a respective stack of sample blocks comprises one or more overlapping sample blocks.

In a further possible implementation form of the first aspect, the processing circuitry is configured to generate the respective current filtered sample block on the basis of the one or more filtered stacks of sample blocks by averaging those sample blocks of the one or more filtered stacks of sample blocks, which at least partially overlap the current sample block.

In a further possible implementation form of the first aspect, the processing circuitry is configured to determine the respective stack of sample blocks on the basis of the similarity measure by using the application map, wherein the processing circuitry is configured to determine the one or more further blocks similar to the respective current sample block using sample blocks only from those regions of the plurality of regions defined by the application map, where the one or more filtered sample blocks are to be used for generating the filtered reconstructed picture.

In a further possible implementation form of the first aspect, the processing circuitry is configured to determine the one or more further sample blocks similar to the respective current sample block by determining on the basis of the similarity measure for each of the one or more further sample blocks a similarity measure value and by comparing the similarity measure value with a threshold value.

In a further possible implementation form of the first aspect, the processing circuitry is configured to collectively filter the respective stack of sample blocks to obtain the respective filtered stack of sample blocks on the basis of the application map by collectively filtering only those sample blocks of the respective stack of sample blocks from regions of the plurality of regions defined by the application map, where the one or more filtered sample blocks are to be used for generating the filtered reconstructed picture.

In a further possible implementation form of the first aspect, each region of the plurality of regions defined by the application map comprises at least one of the one or more sample blocks defined by the first partition.

According to a second aspect, the disclosure relates to a video encoding apparatus for encoding a picture of a video stream. The video encoding apparatus comprises: a picture reconstruction unit configured to reconstruct the picture; and a loop filter apparatus according to the first aspect or any one of its implementation forms for processing the reconstructed picture into a filtered reconstructed picture.

In a further possible implementation form of the second aspect, the processing circuitry is configured, in a first processing stage, to:
apply the first partition to the reconstructed picture or at least a portion thereof for partitioning the reconstructed picture into the plurality of sample blocks;
filter the plurality of sample blocks by applying a respective noise suppression filter to the plurality of sample blocks for obtaining a plurality of filtered sample blocks; and
generate the application map on the basis of the plurality of sample blocks and the plurality of filtered sample blocks using a performance measure, in particular a rate distortion measure;
wherein in a second processing stage the processing circuitry is configured to:
filter the one or more of the plurality of sample blocks by applying a respective noise suppression filter to the one or more of the plurality of sample blocks for obtaining one or more filtered sample blocks, wherein the one or more of the plurality of sample blocks are defined by the application map generated in the first processing stage and wherein the noise suppression filter depends on the application map, wherein the application map partitions the reconstructed picture into a plurality of regions and defines for each region of the plurality of regions to use at least one of the one or more filtered sample blocks or one or more unfiltered sample blocks of the plurality of sample blocks from the respective region for generating the filtered reconstructed picture; and
generate the filtered reconstructed picture on the basis of the one or more unfiltered sample blocks and the one or more filtered sample blocks.

In a further possible implementation form of the second aspect, in the first processing stage the processing circuitry is configured to: filter the plurality of sample blocks by applying a respective noise suppression filter to the plurality of sample blocks for obtaining a plurality of filtered sample blocks using a dummy application map, wherein the dummy application map partitions the reconstructed picture into a plurality of regions and defines for each region of the plurality of regions to use [at least one of] the plurality of filtered sample blocks from the respective region for generating the filtered reconstructed picture.

In a further possible implementation form of the second aspect, the video encoding apparatus further comprises an entropy encoding unit configured to encode the application map in an encoded video stream, e.g. a bitstream.

According to a third aspect, the disclosure relates to a video decoding apparatus for decoding a picture of an encoded video stream, e.g. a bitstream. The video decoding apparatus comprises: a picture reconstruction unit configured to reconstruct the picture; and a loop filter apparatus according to the first aspect or any one of its implementation forms for processing the reconstructed picture into a filtered reconstructed picture.

In a further possible implementation form of the third aspect, the video decoding apparatus further comprises an entropy decoding unit configured to decode the application map using the encoded video stream.

According to a fourth aspect, the disclosure relates to a corresponding loop filtering method for processing a reconstructed picture of a video stream into a filtered reconstructed picture, wherein the reconstructed picture comprises a plurality of samples, wherein each sample is associated with a sample value. The loop filtering method comprises the steps of:
applying a first partition to the reconstructed picture or at least a portion thereof for partitioning the reconstructed picture into a plurality of sample blocks;
filtering one or more of the plurality of sample blocks by applying a respective noise suppression filter to the one or more of the plurality of sample blocks for obtaining one or more filtered sample blocks, wherein the one or more of the plurality of sample blocks are defined by an application map and wherein the noise suppression filter depends on the application map, wherein the application map partitions the reconstructed picture into a plurality of regions and defines for each region of the plurality of regions to use at least one of the one or more filtered sample blocks or one or more unfiltered sample blocks of the plurality of sample blocks from the respective region for generating the filtered reconstructed picture; and
generating the filtered reconstructed picture on the basis of the one or more unfiltered sample blocks and the one or more filtered sample blocks.

The loop filtering method according to the fourth aspect can be performed by the loop filter apparatus according to the first aspect. Further features of the loop filtering method according to the fourth aspect result directly from the functionality of the loop filter apparatus according to the first aspect and its different implementation forms described above and below.

According to a fifth aspect, the disclosure relates to a computer program product comprising program code for performing the method according to the fourth aspect when executed on a computer.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments are described in more detail with reference to the attached figures and drawings, in which:

FIG. 1 is a block diagram showing an example of a video encoder configured to implement embodiments of the present disclosure;

FIG. 2 is a block diagram showing an example structure of a video decoder configured to implement embodiments of the present disclosure;

FIG. 3 is a block diagram showing an example of a video coding system configured to implement embodiments of the present disclosure;

FIG. 4 is a block diagram showing an example of a loop filter apparatus implemented in a video encoder;

FIG. 5 is a block diagram showing an example of a loop filter apparatus implemented in a video decoder;

FIG. 6 is a block diagram showing an example of a noise suppression processing chain implemented in the loop filter apparatus of FIG. 4 and FIG. 5;

FIG. 7 is a flow diagram showing an example of some of the steps of the noise suppression processing chain of FIG. 6;

FIG. 8 is a schematic diagram showing a portion of a reconstructed picture with a current block and a plurality of similar blocks used in the noise suppression processing chain of FIG. 6;

FIG. 9 is a schematic diagram showing a stack of blocks and a stack of filtered blocks used in the noise suppression processing chain of FIG. 6;

FIG. 10 is a schematic diagram showing a portion of a reconstructed picture with a current block and a plurality of stacks of filtered blocks used in the noise suppression processing chain of FIG. 6;

FIG. 11 is a schematic diagram showing a portion of an application map used in the noise suppression processing chain of FIG. 6;

FIG. 12 is a schematic diagram showing a portion of a reconstructed picture with a current block and a plurality of similar blocks overlaid on top of the application map of FIG. 11;

FIG. 13 is a block diagram showing an example of a noise suppression processing chain implemented in a loop filter apparatus according to an embodiment;

FIG. 14 is a flow diagram showing an example of some of the steps of the noise suppression processing chain of FIG. 13;

FIG. 15 is a block diagram showing an example of a noise suppression processing chain implemented in a loop filter apparatus according to a further embodiment;

FIG. 16 is a flow diagram showing an example of some of the steps of the noise suppression processing chain of FIG. 15;

FIG. 17 is a block diagram showing an example of a loop filter apparatus according to an embodiment implemented in a video encoder;

FIG. 18 is a block diagram showing an example of a loop filter apparatus according to an embodiment implemented in a video decoder; and

FIG. 19 is a flow diagram showing an example of a loop filtering method according to an embodiment.

In the following identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the invention or specific aspects in which embodiments of the present invention may be used. It is understood that embodiments of the invention may be used in other aspects and comprise structural or logical changes not depicted in the figures. The following detailed description, therefore, is not to be taken in a limiting sense, and the scope of the present invention is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

Video coding typically refers to the processing of a sequence of pictures, which form the video or video sequence. Instead of the term picture, the terms frame or image may be used as synonyms in the field of video coding. Video coding comprises two parts, video encoding and video decoding. Video encoding is performed at the source side, typically comprising processing (e.g. by compression) the original video pictures to reduce the amount of data required for representing the video pictures (for more efficient storage and/or transmission). Video decoding is performed at the destination side and typically comprises the inverse processing compared to the encoder to reconstruct the video pictures. Embodiments referring to “coding” of video pictures (or pictures in general, as will be explained later) shall be understood to relate to both, “encoding” and “decoding” of video pictures. The combination of the encoding part and the decoding part is also referred to as CODEC (COding and DECoding).

In case of lossless video coding, the original video pictures can be completely reconstructed, i.e. the reconstructed video pictures have the same quality as the original video pictures (assuming no transmission loss or other data loss during storage or transmission). In case of lossy video coding, further compression, e.g. by quantization, is performed, to reduce the amount of data representing the video pictures, which cannot be completely reconstructed at the decoder, i.e. the quality of the reconstructed video pictures is lower or worse compared to the quality of the original video pictures.

Several video coding standards since H.261 belong to the group of “lossy hybrid video codecs” (i.e. combine spatial and temporal prediction in the sample domain and 2D transform coding for applying quantization in the transform domain). Each picture of a video sequence is typically partitioned into a set of non-overlapping blocks and the coding is typically performed on a block level. In other words, at the encoder the video is typically processed, i.e. encoded, on a block (video block) level, e.g. by using spatial (intra picture) prediction and temporal (inter picture) prediction to generate a prediction block, subtracting the prediction block from the current block (block currently processed or to be processed) to obtain a residual block, transforming the residual block and quantizing the residual block in the transform domain to reduce the amount of data to be transmitted (compression), whereas at the decoder the inverse processing compared to the encoder is applied to the encoded or compressed block to reconstruct the current block for representation. Furthermore, the encoder duplicates the decoder processing loop such that both will generate identical predictions (e.g. intra- and inter predictions) and/or re-constructions for processing, i.e. coding, the subsequent blocks.

As video picture processing (also referred to as moving picture processing) and still picture processing (the term processing comprising coding in this application), share many concepts and technologies or tools, in the following the term “picture” is used to refer to a video picture of a video sequence (as explained above) and/or to a still picture to avoid unnecessary repetitions and distinctions between video pictures and still pictures, where not necessary. In case the description refers to still pictures (or still images) only, the term “still picture” shall be used.

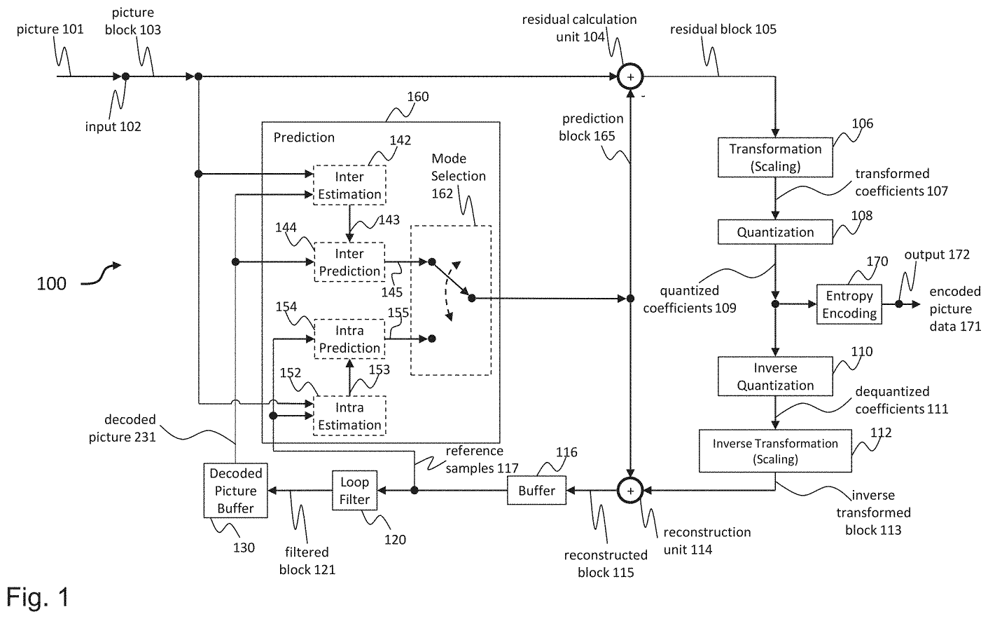

In the following, embodiments of an encoder 100, a decoder 200, and a coding system 300 are described based on FIGS. 1 to 3.

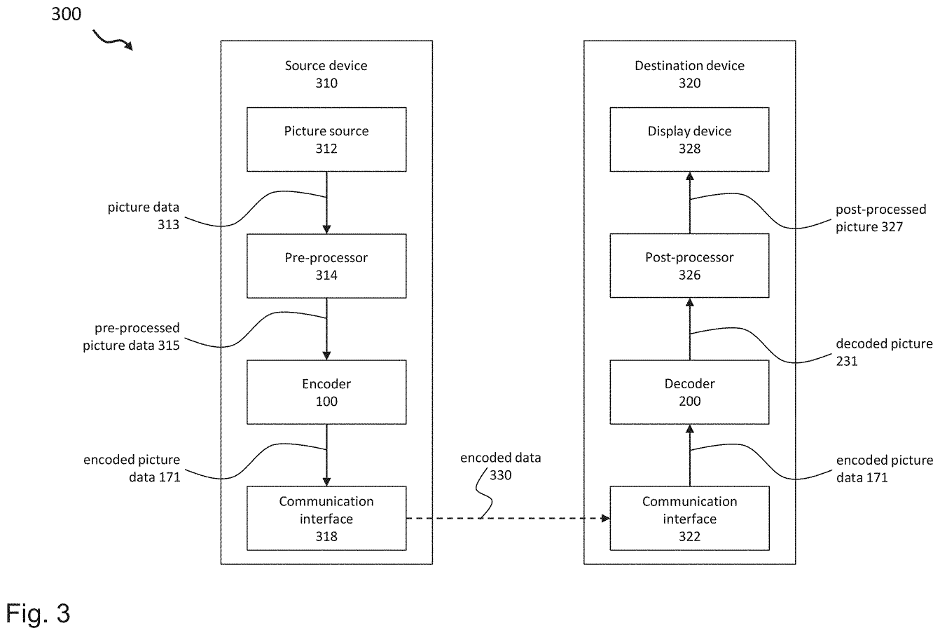

FIG. 3 is a conceptional or schematic block diagram illustrating an embodiment of a coding system 300, e.g. a picture coding system 300, wherein the coding system 300 comprises a source device 310 configured to provide encoded data 330, e.g. an encoded picture 330, e.g. to a destination device 320 for decoding the encoded data 330.

The source device 310 comprises an encoder 100 or encoding unit 100, and may additionally, i.e. optionally, comprise a picture source 312, a pre-processing unit 314, e.g. a picture pre-processing unit 314, and a communication interface or communication unit 318.

The picture source 312 may comprise or be any kind of picture capturing device, for example for capturing a real-world picture, and/or any kind of a picture generating device, for example a computer-graphics processor for generating a computer animated picture, or any kind of device for obtaining and/or providing a real-world picture, a computer animated picture (e.g. a screen content, a virtual reality (VR) picture) and/or any combination thereof (e.g. an augmented reality (AR) picture). In the following, all these kinds of pictures and any other kind of picture will be referred to as “picture”, unless specifically described otherwise, while the previous explanations with regard to the term “picture” covering “video pictures” and “still pictures” still hold true, unless explicitly specified differently.

A (digital) picture is or can be regarded as a two-dimensional array or matrix of samples with intensity values. A sample in the array may also be referred to as pixel (short form of picture element) or a pel. The number of samples in horizontal and vertical direction (or axis) of the array or picture define the size and/or resolution of the picture. For representation of color, typically three color components are employed, i.e. the picture may be represented or include three sample arrays. In RBG format or color space a picture comprises a corresponding red, green and blue sample array. However, in video coding each pixel is typically represented in a luminance/chrominance format or color space, e.g. YCbCr, which comprises a luminance component indicated by Y (sometimes also L is used instead) and two chrominance components indicated by Cb and Cr. The luminance (or short luma) component Y represents the brightness or grey level intensity (e.g. like in a grey-scale picture), while the two chrominance (or short chroma) components Cb and Cr represent the chromaticity or color information components. Accordingly, a picture in YCbCr format comprises a luminance sample array of luminance sample values (Y), and two chrominance sample arrays of chrominance values (Cb and Cr). Pictures in RGB format may be converted or transformed into YCbCr format and vice versa, the process is also known as color transformation or conversion. If a picture is monochrome, the picture may comprise only a luminance sample array.

The picture source 312 may be, for example a camera for capturing a picture, a memory, e.g. a picture memory, comprising or storing a previously captured or generated picture, and/or any kind of interface (internal or external) to obtain or receive a picture. The camera may be, for example, a local or integrated camera integrated in the source device, the memory may be a local or integrated memory, e.g. integrated in the source device. The interface may be, for example, an external interface to receive a picture from an external video source, for example an external picture capturing device like a camera, an external memory, or an external picture generating device, for example an external computer-graphics processor, computer or server. The interface can be any kind of interface, e.g. a wired or wireless interface, an optical interface, according to any proprietary or standardized interface protocol. The interface for obtaining the picture data 312 may be the same interface as or a part of the communication interface 318.

In distinction to the pre-processing unit 314 and the processing performed by the pre-processing unit 314, the picture or picture data 313 may also be referred to as raw picture or raw picture data 313.

The pre-processing unit 314 is configured to receive the (raw) picture data 313 and to perform pre-processing on the picture data 313 to obtain a pre-processed picture 315 or pre-processed picture data 315. Pre-processing performed by the pre-processing unit 314 may, e.g., comprise trimming, color format conversion (e.g. from RGB to YCbCr), color correction, or de-noising.

The encoder 100 is configured to receive the pre-processed picture data 315 and provide encoded picture data 171 (further details will be described, e.g., based on FIG. 1).

Communication interface 318 of the source device 310 may be configured to receive the encoded picture data 171 and to directly transmit it to another device, e.g. the destination device 320 or any other device, for storage or direct reconstruction, or to process the encoded picture data 171 respectively before storing the encoded data 330 and/or transmitting the encoded data 330 to another device, e.g. the destination device 320 or any other device for decoding or storing.

The destination device 320 comprises a decoder 200 or decoding unit 200, and may additionally, i.e. optionally, comprise a communication interface or communication unit 322, a post-processing unit 326 and a display device 328.

The communication interface 322 of the destination device 320 is configured receive the encoded picture data 171 or the encoded data 330, e.g. directly from the source device 310 or from any other source, e.g. a memory, e.g. an encoded picture data memory.

The communication interface 318 and the communication interface 322 may be configured to transmit and receive, respectively, the encoded picture data 171 or encoded data 330 via a direct communication link between the source device 310 and the destination device 320, e.g. a direct wired or wireless connection, or via any kind of network, e.g. a wired or wireless network or any combination thereof, or any kind of private and public network, or any kind of combination thereof.

The communication interface 318 may be, e.g., configured to package the encoded picture data 171 into an appropriate format, e.g. packets, for transmission over a communication link or communication network, and may further comprise data loss protection and data loss recovery.

The communication interface 322, forming the counterpart of the communication interface 318, may be, e.g., configured to de-package the encoded data 330 to obtain the encoded picture data 171 and may further be configured to perform data loss protection and data loss recovery, e.g. comprising error concealment.

Both, communication interface 318 and communication interface 322 may be configured as unidirectional communication interfaces as indicated by the arrow for the encoded picture data 330 in FIG. 3 pointing from the source device 310 to the destination device 320, or bi-directional communication interfaces, and may be configured, e.g. to send and receive messages, e.g. to set up a connection, to acknowledge and/or re-send lost or delayed data including picture data, and exchange any other information related to the communication link and/or data transmission, e.g. encoded picture data transmission.

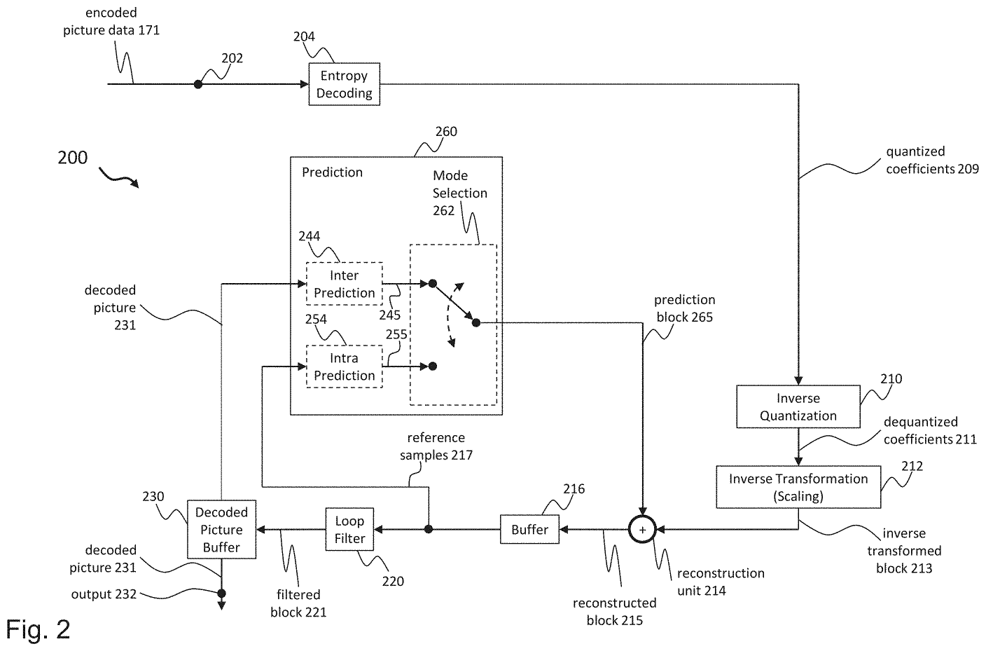

The decoder 200 is configured to receive the encoded picture data 171 and provide decoded picture data 231 or a decoded picture 231 (further details will be described, e.g., based on FIG. 2).

The post-processor 326 of destination device 320 is configured to post-process the decoded picture data 231, e.g. the decoded picture 231, to obtain post-processed picture data 327, e.g. a post-processed picture 327. The post-processing performed by the post-processing unit 326 may comprise, e.g. color format conversion (e.g. from YCbCr to RGB), color correction, trimming, or re-sampling, or any other processing, e.g. for preparing the decoded picture data 231 for display, e.g. by display device 328.

The display device 328 of the destination device 320 is configured to receive the post-processed picture data 327 for displaying the picture, e.g. to a user or viewer. The display device 328 may be or comprise any kind of display for representing the reconstructed picture, e.g. an integrated or external display or monitor. The displays may, e.g. comprise cathode ray tubes (CRT), liquid crystal displays (LCD), plasma displays, organic light emitting diodes (OLED) displays or any kind of other display.

Although FIG. 3 depicts the source device 310 and the destination device 320 as separate devices, embodiments of devices may also comprise both or both functionalities, the source device 310 or corresponding functionality and the destination device 320 or corresponding functionality. In such embodiments the source device 310 or corresponding functionality and the destination device 320 or corresponding functionality may be implemented using the same hardware and/or software or by separate hardware and/or software or any combination thereof.

As will be apparent for the skilled person based on the description, the existence and split of functionalities of the different units or functionalities within the source device 310 and/or destination device 320 as shown in FIG. 3 may vary depending on the actual device and application.

Therefore, the source device 310 and the destination device 320 as shown in FIG. 3 are just example embodiments in which the invention can be implemented, and embodiments of the invention are not limited to those shown in FIG. 3.

Source device 310 and destination device 320 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices, broadcast receiver device, or the like and may use no or any kind of operating system.

FIG. 1 shows a schematic/conceptual block diagram of an embodiment of an encoder 100, e.g. a picture encoder 100, which comprises an input 102, a residual calculation unit 104, a transformation unit 106, a quantization unit 108, an inverse quantization unit 110, and inverse transformation unit 112, a reconstruction unit 114, a buffer 116, a loop filter apparatus 120 according to an embodiment, a decoded picture buffer (DPB) 130, a prediction unit 160, including an inter estimation unit 142, an inter prediction unit 144, an intra-estimation unit 152, and an intra-prediction unit 154, a mode selection unit 162, an entropy encoding unit 170, and an output 172. A video encoder 100 as shown in FIG. 1 may also be referred to as hybrid video encoder or a video encoder according to a hybrid video codec.

For example, the residual calculation unit 104, the transformation unit 106, the quantization unit 108, and the entropy encoding unit 170 form a forward signal path of the encoder 100, whereas, for example, the inverse quantization unit 110, the inverse transformation unit 112, the reconstruction unit 114, the buffer 116, the loop filter 120 according to an embodiment, the decoded picture buffer (DPB) 130, the inter prediction unit 144, and the intra-prediction unit 154 form a backward signal path of the encoder, wherein the backward signal path of the encoder corresponds to the signal path of the decoder (see decoder 200 in FIG. 2).

The encoder is configured to receive, e.g. by input 102, a picture 101 or a picture block 103 of the picture 101, e.g. picture of a sequence of pictures forming a video or video sequence. The picture block 103 may also be referred to as current picture block or picture block to be coded, and the picture 101 as current picture or picture to be coded (in particular in video coding to distinguish the current picture from other pictures, e.g. previously encoded and/or decoded pictures of the same video sequence, i.e. the video sequence which also comprises the current picture).

Embodiments of the encoder 100 may comprise a partitioning unit (not depicted in FIG. 1), e.g. which may also be referred to as picture partitioning unit, configured to partition the picture 103 into a plurality of blocks, e.g. blocks like block 103, typically into a plurality of non-overlapping blocks. The partitioning unit may be configured to use the same block size for all pictures of a video sequence and the corresponding grid defining the block size, or to change the block size between pictures or subsets or groups of pictures, and partition each picture into the corresponding blocks.

Like the picture 101, the block 103 again is or can be regarded as a two-dimensional array or matrix of samples with intensity values (sample values), although of smaller dimension than the picture 101. In other words, the block 103 may comprise, e.g., one sample array (e.g. a luma array in case of a monochrome picture 101) or three sample arrays (e.g. a luma and two chroma arrays in case of a color picture 101) or any other number and/or kind of arrays depending on the color format applied. The number of samples in horizontal and vertical direction (or axis) of the block 103 define the size of block 103.

Encoder 100 as shown in FIG. 1 is configured encode the picture 101 block by block, e.g. the encoding and prediction is performed per block 103.

The residual calculation unit 104 is configured to calculate a residual block 105 based on the picture block 103 and a prediction block 165 (further details about the prediction block 165 are provided later), e.g. by subtracting sample values of the prediction block 165 from sample values of the picture block 103, sample by sample (pixel by pixel) to obtain the residual block 105 in the sample domain.

The transformation unit 106 is configured to apply a transformation, e.g. a spatial frequency transform or a linear spatial transform, e.g. a discrete cosine transform (DCT) or discrete sine transform (DST), on the sample values of the residual block 105 to obtain transformed coefficients 107 in a transform domain. The transformed coefficients 107 may also be referred to as transformed residual coefficients and represent the residual block 105 in the transform domain.

The transformation unit 106 may be configured to apply integer approximations of DCT/DST, such as the core transforms specified for HEVC/H.265. Compared to an orthonormal DCT transform, such integer approximations are typically scaled by a certain factor. In order to preserve the norm of the residual block 105 which is processed by forward and inverse transforms, additional scaling factors can be applied as part of the transform process. The scaling factors are typically chosen based on certain constraints like scaling factors being a power of two for shift operation, bit depth of the transformed coefficients, tradeoff between accuracy and implementation costs, etc. Specific scaling factors are, for example, specified for the inverse transform, e.g. by inverse transformation unit 212, at the decoder 200 (and the corresponding inverse transform, e.g. by inverse transformation unit 112 at the encoder 100) and corresponding scaling factors for the forward transform, e.g. by transformation unit 106, at the encoder 100 may be specified accordingly.

The quantization unit 108 is configured to quantize the transformed coefficients 107 to obtain quantized coefficients 109, e.g. by applying scalar quantization or vector quantization. The quantized coefficients 109 may also be referred to as quantized residual coefficients 109. For example for scalar quantization, different scaling may be applied to achieve finer or coarser quantization. Smaller quantization step sizes correspond to finer quantization, whereas larger quantization step sizes correspond to coarser quantization. The applicable quantization step size may be indicated by a quantization parameter (QP). The quantization parameter may for example be an index to a predefined set of applicable quantization step sizes. For example, small quantization parameters may correspond to fine quantization (small quantization step sizes) and large quantization parameters may correspond to coarse quantization (large quantization step sizes) or vice versa. The quantization may include division by a quantization step size and a corresponding or inverse dequantization, e.g. by inverse quantization 110, may include multiplication by the quantization step size. Embodiments according to HEVC, may be configured to use a quantization parameter to determine the quantization step size. Generally, the quantization step size may be calculated based on a quantization parameter using a fixed point approximation of an equation including division. Additional scaling factors may be introduced for quantization and dequantization to restore the norm of the residual block, which might get modified because of the scaling used in the fixed point approximation of the equation for quantization step size and quantization parameter. In one example implementation, the scaling of the inverse transform and dequantization might be combined. Alternatively, customized quantization tables may be used and signaled from the encoder 100 to the decoder 200, e.g. in a bitstream. The quantization is a lossy operation, wherein the loss increases with increasing quantization step sizes.

Embodiments of the encoder 100 may be configured to output the quantization scheme and quantization step size, e.g. by means of the corresponding quantization parameter, so that the decoder 200 may receive and apply the corresponding inverse quantization. Embodiments of the encoder 100 (or quantization unit 108) may be configured to output the quantization scheme and quantization step size, e.g. directly or entropy encoded via the entropy encoding unit 170 or any other entropy coding unit.

The inverse quantization unit 110 of the encoder 100 is configured to apply the inverse quantization of the quantization unit 108 on the quantized coefficients to obtain dequantized coefficients 111, e.g. by applying the inverse of the quantization scheme applied by the quantization unit 108 based on or using the same quantization step size as the quantization unit 108. The dequantized coefficients 111 may also be referred to as dequantized residual coefficients 111 and correspond, although typically not identically due to the loss by quantization, to the transformed coefficients 108[CB1].

The inverse transformation unit 112 of the encoder 100 is configured to apply the inverse transformation of the transformation applied by the transformation unit 106, e.g. an inverse discrete cosine transform (DCT) or inverse discrete sine transform (DST), to obtain an inverse transformed block 113 in the sample domain. The inverse transformed block 113 may also be referred to as inverse transformed dequantized block 113 or inverse transformed residual block 113.

The reconstruction unit 114 of the encoder 100 is configured to combine the inverse transformed block 113 and the prediction block 165 to obtain a reconstructed block 115 in the sample domain, e.g. by sample wise adding the sample values of the decoded residual block 113 and the sample values of the prediction block 165.

The buffer unit 116 (or short “buffer” 116), e.g. a line buffer 116, is configured to buffer or store the reconstructed block 115 and the respective sample values, for example for intra estimation and/or intra prediction. In further embodiments, the encoder 100 may be configured to use unfiltered reconstructed blocks and/or the respective sample values stored in buffer unit 116 for any kind of estimation and/or prediction.

As will be described in more detail further below, embodiments of the present disclosure relate to a loop filter apparatus 120 of the encoder 100 and a corresponding loop filter apparatus 220 of the decoder 200. Generally, the loop filter apparatus 120, 220 according to an embodiment is configured to process a reconstructed picture of a video stream or at least a portion thereof into a filtered reconstructed picture.

More specifically, the loop filter apparatus 120 (or short “loop filter” 120) is configured to filter the reconstructed block 115 to obtain a filtered block 121. In addition to the filtering provided by the loop filter apparatus 120, 220, which is in particular for noise suppression and will be described in more detail below, the loop filter apparatus 120 can further comprise a de-blocking sample-adaptive offset (SAO) filter or other filters, e.g. sharpening or smoothing filters. The filtered block 121 may also be referred to as filtered reconstructed block 121.

Embodiments of the loop filter apparatus 120 may comprise (not shown in FIG. 1) a filter analysis unit and the actual filter unit, wherein the filter analysis unit is configured to determine loop filter parameters for the actual filter. The filter analysis unit may be configured to apply fixed pre-determined filter parameters to the actual loop filter, adaptively select filter parameters from a set of predetermined filter parameters or adaptively calculate filter parameters for the actual loop filter.

Embodiments of the loop filter apparatus 120 may comprise (not shown in FIG. 1) one or a plurality of sub-filters, e.g. one or more of different kinds or types of filters, e.g. connected in series or in parallel or in any combination thereof, wherein each of the sub-filters may comprise individually or jointly with other sub-filters of the plurality of sub-filters a filter analysis unit to determine the respective loop filter parameters, e.g. as described in the previous paragraph.

Embodiments of the encoder 100 (respectively loop filter apparatus 120) may be configured to output the loop filter parameters, e.g. directly or entropy encoded via the entropy encoding unit 170 or any other entropy coding unit, so that, e.g., the decoder 200 may receive and apply the same loop filter parameters for decoding.

The decoded picture buffer (DPB) 130 of the encoder 100 is configured to receive and store the filtered block 121. The decoded picture buffer 130 may be further configured to store other previously filtered blocks, e.g. previously reconstructed and filtered blocks 121, of the same current picture or of different pictures, e.g. previously reconstructed pictures, and may provide complete previously reconstructed, i.e. decoded, pictures (and corresponding reference blocks and samples) and/or a partially reconstructed current picture (and corresponding reference blocks and samples), for example for inter estimation and/or inter prediction.

Further embodiments of the present disclosure may also be configured to use the previously filtered blocks and corresponding filtered sample values of the decoded picture buffer 130 for any kind of estimation or prediction, e.g. intra and inter estimation and prediction.

The prediction unit 160, also referred to as block prediction unit 160, of the encoder 100 is configured to receive or obtain the picture block 103 (current picture block 103 of the current picture 101) and decoded or at least reconstructed picture data, e.g. reference samples of the same (current) picture from buffer 116 and/or decoded picture data 231 from one or a plurality of previously decoded pictures from decoded picture buffer 130, and to process such data for prediction, i.e. to provide a prediction block 165, which may be an inter-predicted block 145 or an intra-predicted block 155.

The mode selection unit 162 of the encoder 100 may be configured to select a prediction mode (e.g. an intra or inter prediction mode) and/or a corresponding prediction block 145 or 155 to be used as prediction block 165 for the calculation of the residual block 105 and for the reconstruction of the reconstructed block 115.

Embodiments of the mode selection unit 162 may be configured to select the prediction mode (e.g. from those supported by prediction unit 160), which provides the best match or in other words the minimum residual (minimum residual means better compression for transmission or storage), or a minimum signaling overhead (minimum signaling overhead means better compression for transmission or storage), or which considers or balances both. The mode selection unit 162 may be configured to determine the prediction mode based on rate distortion optimization (RDO), i.e. select the prediction mode which provides a minimum rate distortion optimization or which associated rate distortion at least a fulfills a prediction mode selection criterion.

In the following, the prediction processing (e.g. prediction unit 160 and mode selection (e.g. by mode selection unit 162) performed by the encoder 100 according to an embodiment will be explained in more detail.

As described above, encoder 100 is configured to determine or select the best or an optimum prediction mode from a set of (pre-determined) prediction modes. The set of prediction modes may comprise, e.g. intra-prediction modes and/or inter-prediction modes.

The set of intra-prediction modes may comprise 32 different intra-prediction modes, e.g. non-directional modes like DC (or mean) mode and planar mode, or directional modes, e.g. as defined in H.264, or may comprise 65 different intra-prediction modes, e.g. non-directional modes like DC (or mean) mode and planar mode, or directional modes, e.g. as defined in H.265.

The set of (possible) inter-prediction modes depends on the available reference pictures (i.e. previous at least partially decoded pictures, e.g. stored in DBP 230) and other inter-prediction parameters, e.g. whether the whole reference picture or only a part, e.g. a search window area around the area of the current block, of the reference picture is used for searching for a best matching reference block, and/or e.g. whether pixel interpolation is applied, e.g. half/semi-pel and/or quarter-pel interpolation, or not.

Additional to the above prediction modes, skip modes and/or direct modes may be applied.

The prediction unit 160 of the encoder 100 may be further configured to partition the block 103 into smaller block partitions or sub-blocks, e.g. iteratively using quad-tree-partitioning (QT), binary partitioning (BT) or triple-tree-partitioning (TT) or any combination thereof, and to perform, e.g., the prediction for each of the block partitions or sub-blocks, wherein the mode selection comprises the selection of the tree-structure of the partitioned block 103 and the prediction modes applied to each of the block partitions or sub-blocks.

The inter estimation unit 142, also referred to as inter picture estimation unit 142, is configured to receive or obtain the picture block 103 (current picture block 103 of the current picture 101) and a decoded picture 231, or at least one or a plurality of previously reconstructed blocks, e.g. reconstructed blocks of one or a plurality of other/different previously decoded pictures 231, for inter estimation (or “inter picture estimation”). For instance, a video sequence may comprise the current picture and the previously decoded pictures 231, or in other words, the current picture and the previously decoded pictures 231 may be part of or form a sequence of pictures forming a video sequence.

The encoder 100 may, e.g., be configured to select a reference block from a plurality of reference blocks of the same or different pictures of the plurality of other pictures and provide a reference picture and/or an offset between the position of the reference block and the position of the current block as inter estimation parameters 143 to the inter prediction unit 144. This offset is also called a motion vector (MV). The inter estimation is also referred to as motion estimation (ME) and the inter prediction also as motion prediction (MP).

The inter prediction unit 144 of the encoder is configured to obtain, e.g. receive, an inter prediction parameter 143 and to perform inter prediction based on or using the inter prediction parameter 143 to obtain an inter prediction block 145.

Although FIG. 1 shows two distinct units (or steps) for the inter-coding, namely inter estimation 142 and inter prediction 152, both functionalities may be performed as one, e.g. by testing all possible or a predetermined subset of possible inter prediction modes iteratively while storing the currently best inter prediction mode and respective inter prediction block, and using the currently best inter prediction mode and respective inter prediction block as the (final) inter prediction parameter 143 and inter prediction block 145 without performing another time the inter prediction 144.

The intra estimation unit 152 is configured to obtain, e.g. receive, the picture block 103 (current picture block) and one or a plurality of previously reconstructed blocks, e.g. reconstructed neighbor blocks, of the same picture for intra estimation. The encoder 100 may, e.g., be configured to select an intra prediction mode from a plurality of (predetermined) intra prediction modes and provide it as intra estimation parameter 153 to the intra prediction unit 154.

Although FIG. 1 shows two distinct units (or steps) for the intra-coding, namely intra estimation 152 and intra prediction 154, both functionalities may be performed as one, e.g. by testing all possible or a predetermined subset of possible intra-prediction modes iteratively while storing the currently best intra prediction mode and respective intra prediction block, and using the currently best intra prediction mode and respective intra prediction block as the (final) intra prediction parameter 153 and intra prediction block 155 without performing another time the intra prediction 154.

The entropy encoding unit 170 of the encoder 100 is configured to apply an entropy encoding algorithm or scheme (e.g. a variable length coding (VLC) scheme, an context adaptive VLC scheme (CALVC), an arithmetic coding scheme, a context adaptive binary arithmetic coding (CABAC)) on the quantized residual coefficients 109, inter prediction parameters 143, intra prediction parameter 153, and/or loop filter parameters, individually or jointly (or not at all) to obtain encoded picture data 171 which can be output by the output 172, e.g. in the form of an encoded bitstream 171.

FIG. 2 shows an exemplary video decoder 200 configured to receive encoded picture data (e.g. encoded bitstream) 171, e.g. encoded by encoder 100, to obtain a decoded picture 231.

The decoder 200 comprises an input 202, an entropy decoding unit 204, an inverse quantization unit 210, an inverse transformation unit 212, a reconstruction unit 214, a buffer 216, the loop filter 220 according to an embodiment, a decoded picture buffer 230, a prediction unit 260, including an inter prediction unit 244 and an intra prediction unit 254, a mode selection unit 260 and an output 232.

The entropy decoding unit 204 of the decoder 200 is configured to perform entropy decoding to the encoded picture data 171 to obtain, e.g., quantized coefficients 209 and/or decoded coding parameters (not shown in FIG. 2), e.g. any or all of inter prediction parameters 143, intra prediction parameter 153, and/or loop filter parameters.

In embodiments of the decoder 200, the inverse quantization unit 210, the inverse transformation unit 212, the reconstruction unit 214, the buffer 216, the loop filter 220, the decoded picture buffer 230, the prediction unit 260 and the mode selection unit 260 are configured to perform the inverse processing of the encoder 100 (and the respective functional units) to decode the encoded picture data 171.

In particular, the inverse quantization unit 210 may be identical in function to the inverse quantization unit 110, the inverse transformation unit 212 may be identical in function to the inverse transformation unit 112, the reconstruction unit 214 may be identical in function reconstruction unit 114, the buffer 216 may be identical in function to the buffer 116, the loop filter 220 according to an embodiment may be identical in function to the encoder loop filter 120 according to an embodiment (with regard to the actual loop filter as the loop filter 220 typically does not comprise a filter analysis unit to determine the filter parameters based on the original image 101 or block 103 but receives (explicitly or implicitly) or obtains the filter parameters used for (en)coding, e.g. from entropy decoding unit 204), and the decoded picture buffer 230 may be identical in function to the decoded picture buffer 130.

The prediction unit 260 of the decoder 200 may comprise an inter prediction unit 244 and an inter prediction unit 254, wherein the inter prediction unit 144 may be identical in function to the inter prediction unit 144, and the inter prediction unit 154 may be identical in function to the intra prediction unit 154. The prediction unit 260 and the mode selection unit 262 are typically configured to perform the block prediction and/or obtain the predicted block 265 from the encoded data 171 only (without any further information about the original image 101) and to receive or obtain (explicitly or implicitly) the prediction parameters 143 or 153 and/or the information about the selected prediction mode, e.g. from the entropy decoding unit 204.

The decoder 200 is configured to output the decoded picture 230, e.g. via output 232, for presentation or viewing to a user.

As already described above, embodiments of the present disclosure relate to the loop filter apparatus 120 of the encoder 100 and/or to the loop filter apparatus 220 of the decoder 200, in particular for noise suppression. As already described above, the loop filter apparatus 120 of the encoder 100 and the loop filter apparatus 220 of the decoder 200 may contain further sub-filters to the ones described in the following.

Embodiments of the loop filter apparatus 120, 220 are based on a loop filter apparatus disclosed in PCT application PCT/RU2016/000920 “LOW COMPLEXITY MIXED DOMAIN COLLABORATIVE IN-LOOP FILTER FOR LOSSY VIDEO CODING”, which is herein fully incorporated by reference. Before describing embodiments of the loop filter apparatus 120, 220 in more detail, some relevant aspects of the loop filter apparatus disclosed in PCT/RU2016/000920 will be briefly reviewed.

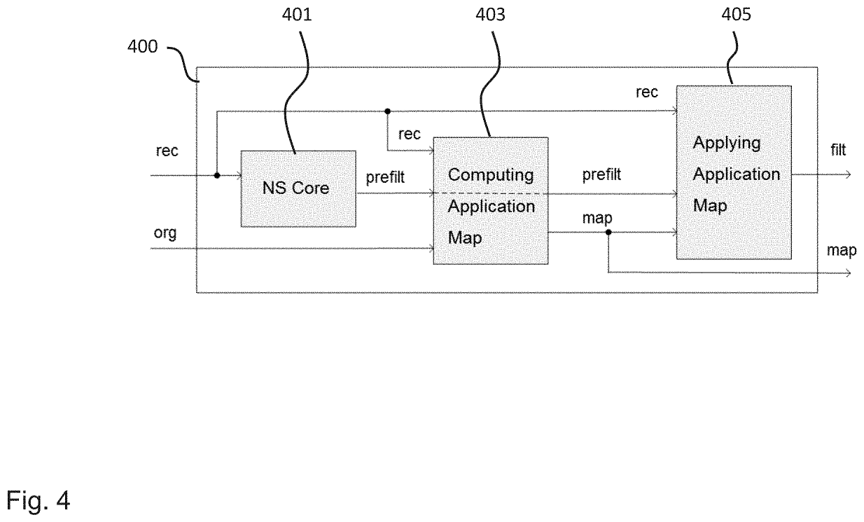

FIG. 4 is a block diagram showing an example of an encoder implementation of a loop filter apparatus 400 disclosed in PCT/RU2016/000920, in particular for noise suppression. The loop filter apparatus 400 shown in FIG. 4 comprises a noise suppression unit 401 (also referred to as “NS Core”) configured to apply a noise suppression filter to the reconstructed picture, a unit 403 configured to determine an application map and a unit 405 configured to apply the application map determined by unit 403 to the reconstructed picture.

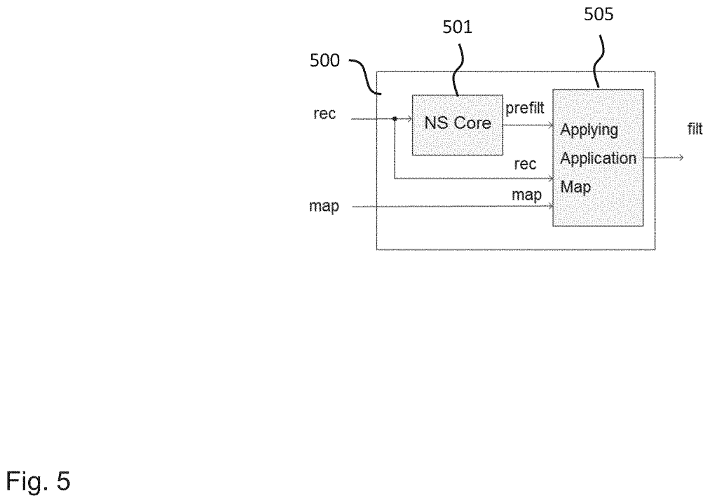

FIG. 5 is a block diagram showing an example of a decoder implementation of a loop filter apparatus 500 disclosed in PCT/RU2016/000920, in particular for noise suppression. The loop filter apparatus 500 shown in FIG. 5 comprises a noise suppression unit 501, which is configured to apply a noise suppression filter to the reconstructed picture and which can be identical to the noise suppression unit 401 of the loop filter apparatus 400 shown in FIG. 4, and a unit 505 configured to apply the application map extracted from the decoded video stream to the reconstructed picture.

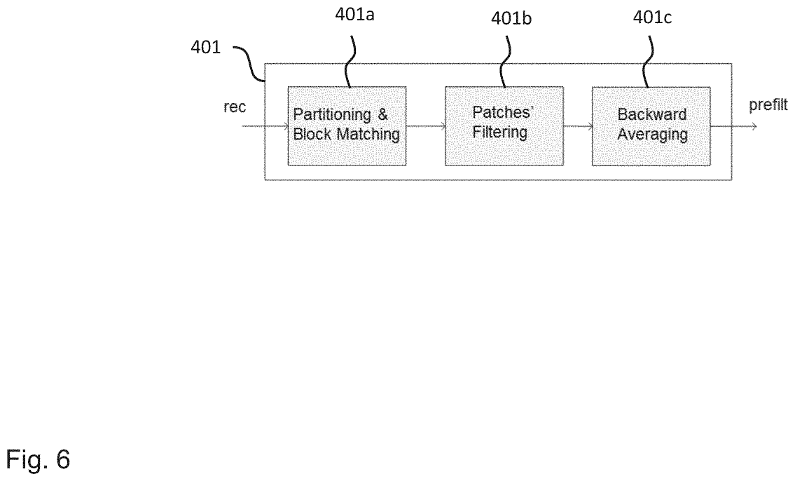

The common component of the loop filter apparatus 400 shown in FIG. 4 and the loop filter apparatus 500 shown in FIG. 5 is the noise suppression unit 401, 501, which is configured to apply a noise suppression filter to the reconstructed picture and which is also referred to as “NS Core” herein. A more detailed view of the noise suppression unit 401 is shown in FIG. 6 with the understanding that the noise suppression unit 501 can be implemented in the same manner.

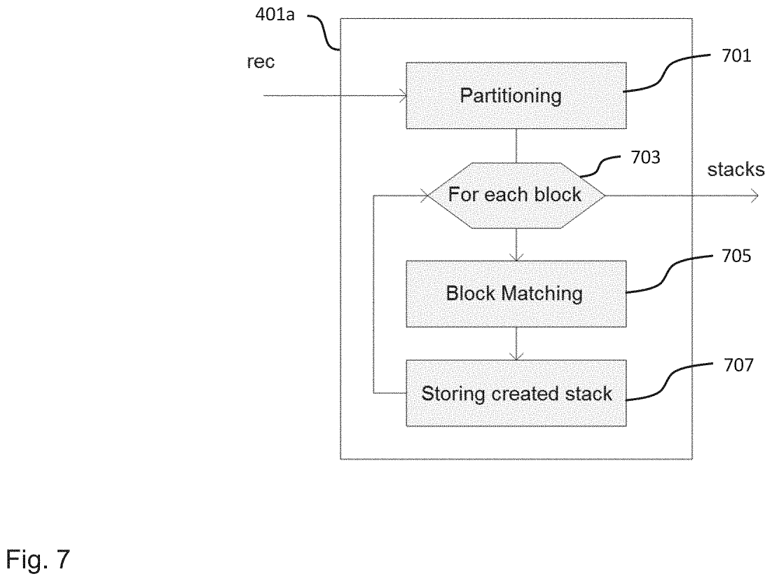

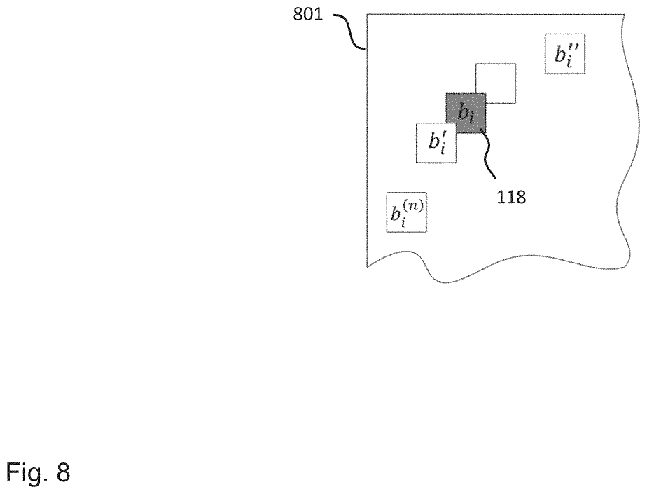

As will be described in more detail further below, the noise suppression unit 401 shown in FIG. 6 comprises a partitioning & block matching unit 401a, a unit 401b for collaboratively filtering sample patches, i.e. blocks and a backward averaging unit 401c. In the partitioning & block matching unit 401a in a first stage (also illustrated as step 701 in FIG. 7), the input, i.e. a reconstructed picture or at least a portion thereof is partitioned into a plurality of square blocks bᵢ (e.g. blocks of K×K size) 118, which are also referred to as “root blocks” bᵢ 118 herein. This partitioning is separate from the codec partitioning, which is used, for example, to obtain the picture blocks 103 up to the reconstructed blocks 115. Then, for each root block bᵢ 118 (step 703 in FIG. 7), a block matching procedure determines patches b′ᵢ, b″ᵢ, . . . , bᵢ⁽ⁿ⁾ (see FIG. 8), i.e. blocks similar to the current root block bᵢ 118 (step 705 in FIG. 7) and collects and stores these as a stack of similar patches, together with root-block bᵢ i.e. blocks (step 707 in FIG. 7). These “patches” may also be referred to as “matching blocks” (indicating that these match, i.e. are similar, to the root-blocks) or “non-root blocks” (distinguishing these from the corresponding root blocks).

FIG. 8 is a schematic diagram showing a portion of a reconstructed picture 801 with a given current root block bᵢ 118 and a plurality of similar blocks b′ᵢ, b″ᵢ, . . . , bᵢ⁽ⁿ⁾ determined by the partitioning & block matching unit 401a of the noise suppression unit 401. For each current root block bᵢ 118, the partitioning & block matching unit 401a tries to find the N closest or best matching blocks based on some metric, e.g. using a mean square error metric, such as the sum of absolute differences, within a search region of the current picture, which can be a predefined parameter. To guarantee some degree of final similarity, the block matching may include thresholds so that the actual number n of patches, i.e. blocks determined by the partitioning & block matching unit 401a may be smaller or equal than N. Eventually, in general, a set of blocks b′ᵢ, b″ᵢ, . . . , bᵢ⁽ⁿ⁾, which are similar to the current block bᵢ 118, are found. The final set of similar blocks are grouped into a stack of blocks including and being associated with the current root block bᵢ 118. Mathematically, this procedure for the current root block bᵢ 118 can be expressed in the following way:

bᵢ→(bᵢ,b′ᵢ,b″ᵢ, . . . ,bᵢ⁽ⁿ⁾),

wherein n is equal or smaller than N. The blocks b′ᵢ, b″ᵢ, . . . , bᵢ⁽ⁿ⁾ of a given stack being similar to the current root block bᵢ 118 are also referred to as non-root blocks as mentioned above.

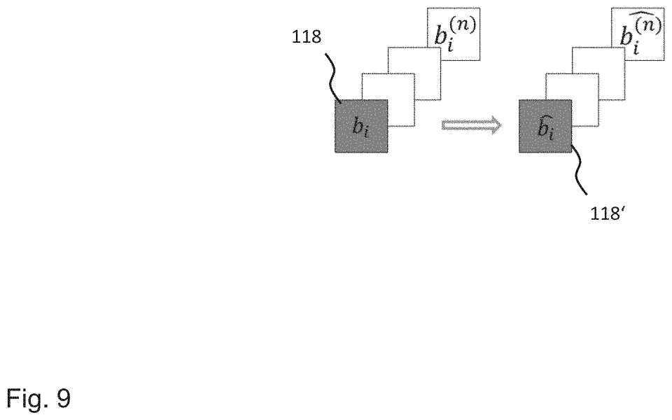

The unit 401b of the noise suppression unit 401 for collaboratively filtering sample patches, i.e. blocks of the noise suppression unit 401 is configured to filter stacks of similar blocks, such as the stack of blocks (bᵢ, b′ᵢ, b″ᵢ, . . . , bᵢ⁽ⁿ⁾) associated with the current root block bᵢ 118. This process is illustrated in FIG. 9, where the stack of blocks (bᵢ, b′ᵢ, b″ᵢ, . . . , bᵢ⁽ⁿ⁾) associated with the current root block bᵢ 118 is collectively processed into the filtered stack of blocks. Mathematically, this can be described as a n to n relation, which processes stack (bᵢ, b′ᵢ, b″ᵢ, . . . , bᵢ⁽ⁿ⁾) into ( [symbol] , [symbol] , [symbol] , . . . , [symbol] ), where each [symbol] is the filtered version of a given block bᵢ.

In an embodiment, the unit 401b is configured to implement a collaborative filtering process in the frequency domain, which can include the following steps:
(i) scanning samples along the blocks, i.e. for each pixel position j=0, 1, . . . , K²−1 putting all pixels on the j-th position from the stack (bᵢ, b′ᵢ, b″ᵢ, . . . , bᵢ⁽ⁿ⁾) into one line lⱼ, wherein |lⱼ|=n+1;
(ii) transforming each lⱼ into tⱼ using a frequency domain transform, such as DCT;
(iii) for each frequency k in tⱼ^{k} performing filtering using the following equation:

$$= \frac{{( {t}_{j}^{k} )}^{2}}{{( {t}_{j}^{k} )}^{2} + {σ}^{2}} ,$$

wherein σ is derived using other codec information, e.g. σ=f(qp), where qp is a quantization parameter, which is known by both the encoder 100 and the decoder 200;
(iv) inverse transforming each [symbol] into the filtered line [symbol] ; and
(v) regrouping each line [symbol] into the filtered stack ( [symbol] , [symbol] , [symbol] , . . . , [symbol] ).

For more details about possible implementations of the collaborative filtering process implemented in unit 401b explicit reference is made to PCT/RU2016/000920.

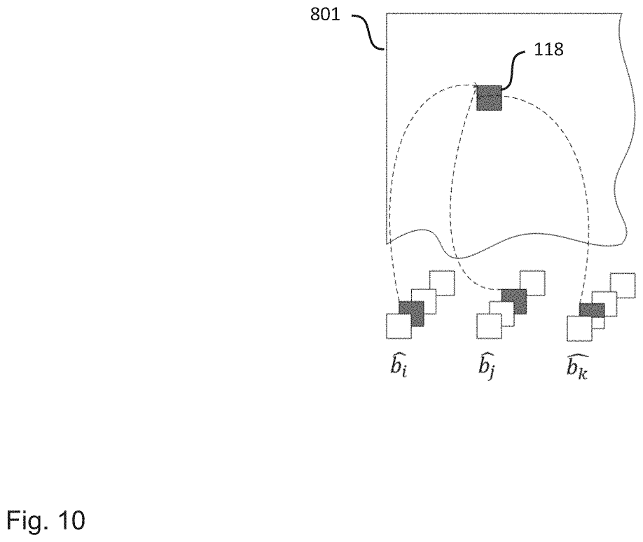

The backward averaging unit 401c of the noise suppression unit 401 is configured to generate for a given current sample block bᵢ 118 a filtered current sample block by performing a backward averaging procedure using the filtered stack of blocks associated with the current sample block bᵢ 118 as well as further filtered stacks of blocks associated with other blocks of the reconstructed picture. As illustrated in FIG. 10, during this backward averaging process one or more blocks of the filtered stacks of blocks are determined, which at least partially overlap the current sample block bᵢ 118, and for each sample position of the current sample block bᵢ 118 the sample values of the at least partially overlapping blocks from the filtered stacks of blocks are averaged. For more details about possible implementations of the backward averaging process implemented in unit 401c explicit reference is made to PCT/RU2016/000920.

In order to avoid an excessive filtering by the noise suppression unit 401 in regions of the reconstructed picture 801, the loop filter apparatus 400 shown in FIG. 4 and the loop filter apparatus 500 shown in FIG. 5 further employ a so called application map. The application map partitions (separately from the codec partitioning) the reconstructed picture 801 (or at least a part thereof) into a plurality of regions, each region comprising a plurality of samples, which may or not be aligned or equal with either root-blocks or reconstructed blocks, and defines for each region to use filtered sample blocks or unfiltered sample blocks for generating the filtered reconstructed picture. In an embodiment, the application map can be a simple binary map, wherein for regions associated with a bit value of “1” (so called 1-marked regions) filtered sample blocks and for regions associated with a bit value of “0” (so called 0-marked regions) unfiltered sample blocks are to be used for generating the filtered reconstructed picture. The unit 403 configured to determine an application map can be configured to determine the application map on the basis of a rate distortion optimization scheme. The such determined application map can be transmitted by means of the encoded bitstream to the decoder 200.

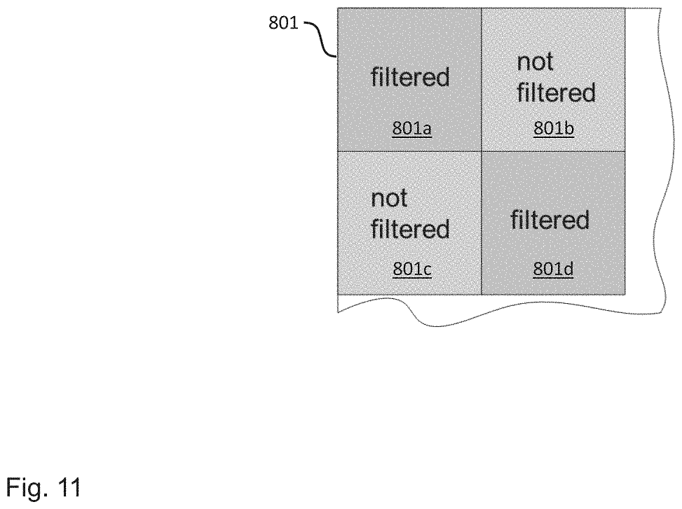

FIG. 11 shows a portion of an exemplary application map overlaid on a portion of the reconstructed picture 801, defining regions 801a, 801d, where filtered sample blocks are to be used for generating the filtered reconstructed picture, and regions 801b, 801c, where unfiltered sample blocks are to be used for generating the filtered reconstructed picture.

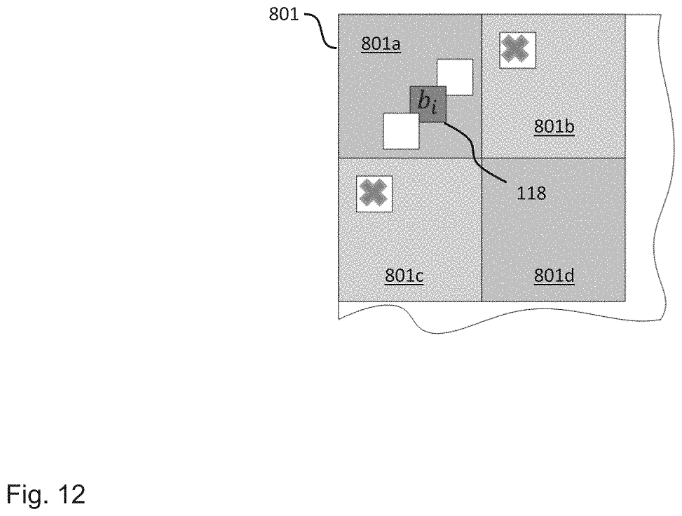

As already described above, in the loop filter apparatus 400 the application map is computed by unit 403 after processing of the reconstructed picture 801 by the noise suppression unit 401, because the unit 403 requires as input the pre-filtered signal (prefilt) from the output of the noise suppression unit 401. For this reason, the following exemplary scenario can occur. As illustrated in FIG. 12, it may happen that some patches, i.e. blocks determined by the partitioning & block matching unit 401a of the noise suppression unit 401 for a current root block bᵢ 118 are located in 0-marked regions of the application map, i.e. in regions of the application map, where the unfiltered sample blocks are to be used for generating the filtered reconstructed picture. For the loop filter apparatus 400 shown in FIG. 4 these patches, i.e. blocks, will still be processed by the units 401b and 401c of the noise suppression unit 401, but eventually excluded in unit 405 of the loop filter apparatus 400, where the application map determined by unit 403 is applied.

In this context it should be mentioned that the patches eventually to be excluded by applying the application map still affect the filtering of the whole stack associated with the current root block bᵢ 118 due to the collaborative filtering procedure performed by unit 401b, but in the backward averaging unit 401c processing these patches, i.e. blocks are redundant. As will be described in more detail further below, embodiments of the present disclosure advantageously allow eliminating this redundancy and, thereby, to decrease the complexity of the loop filter apparatus 120, 220, which is especially important for the decoder 200.

Generally, embodiments of the present disclosure are based on the idea to utilize the application map information already in the noise suppression portion of the processing chain of the loop filter apparatus 120, 220, which allows increasing the quality of the patches, i.e. blocks used for the filtering procedure and removing redundant operations.

More specifically, the loop filter apparatus 120, 220 according to an embodiment comprises processing circuitry configured to: apply a first partition to a reconstructed picture or at least a portion thereof for partitioning the reconstructed picture into a plurality of sample blocks (e.g. root blocks); filter one or more of the plurality of sample blocks by applying a respective noise suppression filter to the one or more of the plurality of sample blocks for obtaining one or more filtered sample blocks, wherein the one or more of the plurality of sample blocks are defined by the application map and wherein the noise suppression filter depends on the application map, wherein the application map partitions the reconstructed picture into a plurality of regions and defines for each region of the plurality of regions to use at least one of the one or more filtered sample blocks or one or more unfiltered sample blocks of the plurality of sample blocks from the respective region for generating the filtered reconstructed picture; and generate the filtered reconstructed picture on the basis of the one or more unfiltered sample blocks and the one or more filtered sample blocks.

In an embodiment, the processing circuitry is configured to apply the noise suppression filter to the respective current sample block, i.e. root block 118 of the one or more sample blocks for obtaining the one or more filtered sample blocks by: determining on the basis of a similarity measure one or more further sample blocks similar to the respective current sample block for obtaining a respective stack of sample blocks, including the current sample block and the one or more further sample blocks; collectively, i.e. joint collaboratively filtering the respective stack of sample blocks to obtain a respective filtered stack of sample blocks; and generating the respective current filtered sample block on the basis of the one or more filtered stacks of sample blocks; wherein the determination of the one or more further sample blocks similar to the respective current sample block and/or the collective filtering of the respective stack of sample blocks depends on the application map.

In an embodiment, a respective stack of sample blocks can comprise one or more overlapping sample blocks, as illustrated, for instance, in FIG. 8.

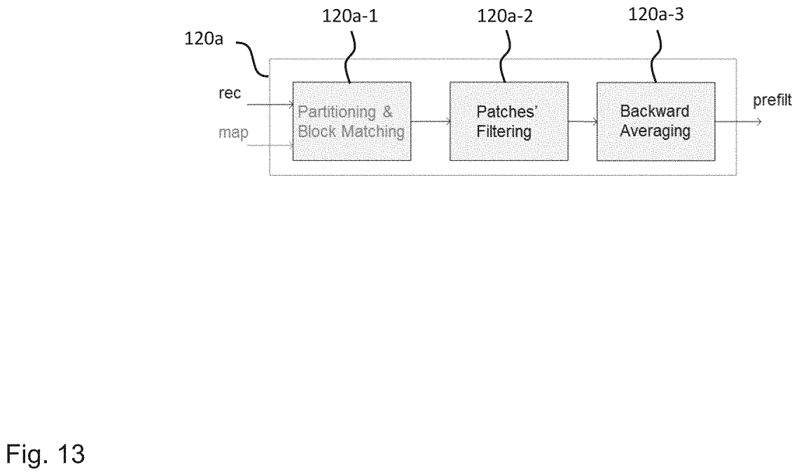

In an embodiment, the processing circuitry of the loop filter apparatus 120, 220 is configured to generate the respective current filtered sample block on the basis of the one or more filtered stacks of sample blocks by averaging the sample blocks of the one or more filtered stacks of sample blocks, which at least partially overlap the current sample block. To this end, the loop filter apparatus 120, 220 can comprise a noise suppression unit 120a (as shown in FIGS. 13, 15, 17 and 18) similar to the noise suppression unit 401 already described above in the context of FIG. 6, but with differences that will be described in more detail in the following.

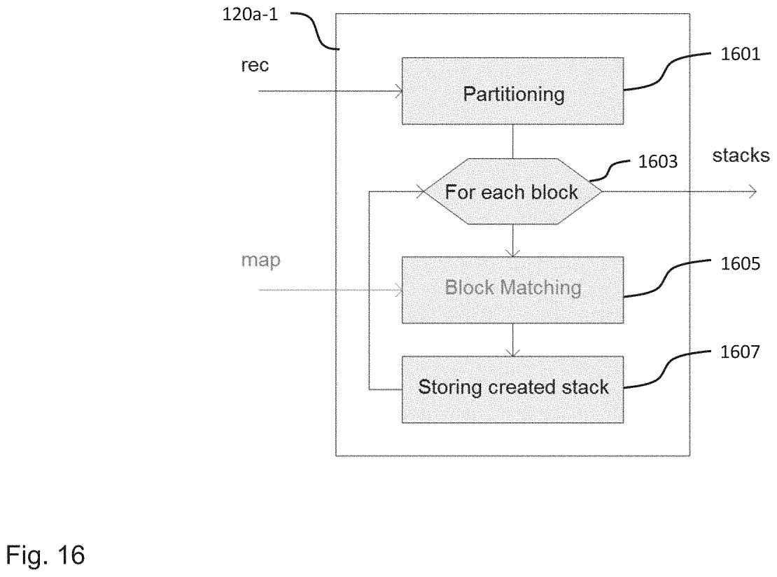

In an embodiment, the processing circuitry of the loop filter apparatus 120, 220 is configured to determine the respective stack of sample blocks on the basis of the similarity measure by using the application map, wherein the processing circuitry is configured to determine the one or more further blocks similar to the respective current sample block using sample blocks only from those regions of the plurality of regions defined by the application map, where the one or more filtered sample blocks are to be used for generating the filtered reconstructed picture. Such an embodiment is illustrated by FIGS. 13 and 16.

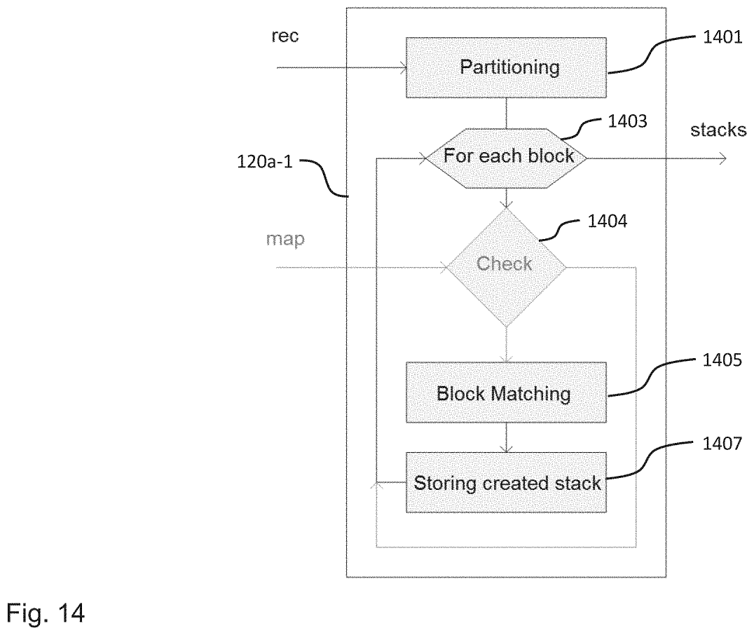

Alternatively, the noise suppression unit 120a of the loop filter apparatus 120 (as well as the equivalent loop filter apparatus 220) may be configured to perform the block matching implemented in the partitioning & block matching unit 120a-1 on the basis of the application map by performing a check (as also illustrated in 1404 of FIG. 14) whether the current root block 118 belongs to a region of the application map, where the filtered sample blocks are to be used for generating the filtered reconstructed frame. If this is the case, processing performs in the way already described in the context of FIG. 7 (steps 1405 and 1407 of FIG. 14 are, for example, equivalent to steps 705 and 707 of FIG. 7). Otherwise, the block is skipped without any further processing and a next block is checked (loop direct from 1404 to 1403). The filtering unit 102a-2 and the backward averaging unit 102a-3 of the noise suppression unit 120a shown in FIG. 13 can be configured, for example, in the same way as the corresponding units shown in FIG. 6.

Both approaches, which are described above and illustrated in general form in FIG. 13 and more detailed in FIG. 14 and FIG. 16, may be applied separately as well as simultaneously.

In a further embodiment based on the embodiment shown in FIG. 13, the partitioning & block matching unit 120a-1 of the noise suppression unit 120a can be configured to exclude those regions from the application map for the block matching procedure, where the application defines that the unfiltered sample blocks are to be used to generate the filtered reconstructed frame.

In an embodiment, the processing circuitry of the loop filter apparatus 120, 220 is configured to determine the one or more further sample blocks similar to the respective current sample block by determining on the basis of the similarity measure for each of the one or more further sample blocks a similarity measure value and by comparing the similarity measure value with a threshold value. As already described in the context of FIG. 6 this similarity measure can be based on a mean square error, such as the sum of absolute differences or the like.

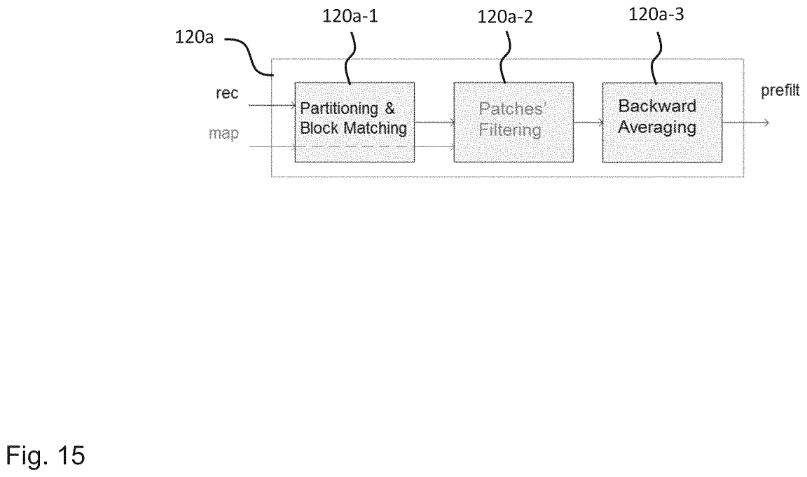

In an embodiment, the processing circuitry of the loop filter apparatus 120, 220 is configured to collectively filter the respective stack of sample blocks to obtain the respective filtered stack of sample blocks on the basis of the application map by collectively filtering only those sample blocks of the respective stack of sample blocks from regions of the plurality of regions defined by the application map, where the one or more filtered sample blocks are to be used for generating the filtered reconstructed picture. Such an embodiment is illustrated in FIG. 15. The noise suppression unit 120a of the loop filter apparatus 120 (as well as the equivalent loop filter apparatus 220) is configured to perform the collaborative filtering on the basis of the application map. In this case, the application map is provided to the patches filtering unit 120a-2 of the noise suppression unit 120 shown in FIG. 15. As illustrated in FIG. 15, the patches filtering unit 120a-2 is configured to receive the set of patches, which have been found in a previous step, i.e. Partitioning & Block Matching, and the application map “map”, and to then check in a step 1605 whether a certain patch or non root block of a stack is from a region of the application map, where the filtered sample blocks are to be used for generating the filtered reconstructed frame. If this is the case, processing performs in the conventional way already described in the context of FIG. 7 (i.e. steps 1601 and 1603 of FIG. 16 are equivalent to steps 701 and 703 of FIG. 7). Otherwise, the block is skipped without any further processing. Also step 1607 of FIG. 16 is equivalent to step 707 of FIG. 7. The partitioning & block matching unit 102a-1 and the backward averaging unit 102a-3 of the noise suppression unit 120a shown in FIG. 15 can be configured in the same way as the corresponding units shown in FIG. 6. With respect to the actual collaborative filtering process the patches filtering unit 102a-2 of the noise suppression unit 102 shown in FIG. 15 can implement the collaborative filtering process described above in the context of the unit 401b shown in FIG. 4.

In an embodiment, each region of the plurality of regions defined by the application map comprises at least one of the one or more sample blocks defined by the first partition. In other words, in an embodiment, the regions defined by the application map can be larger than the sample blocks of the reconstructed picture.

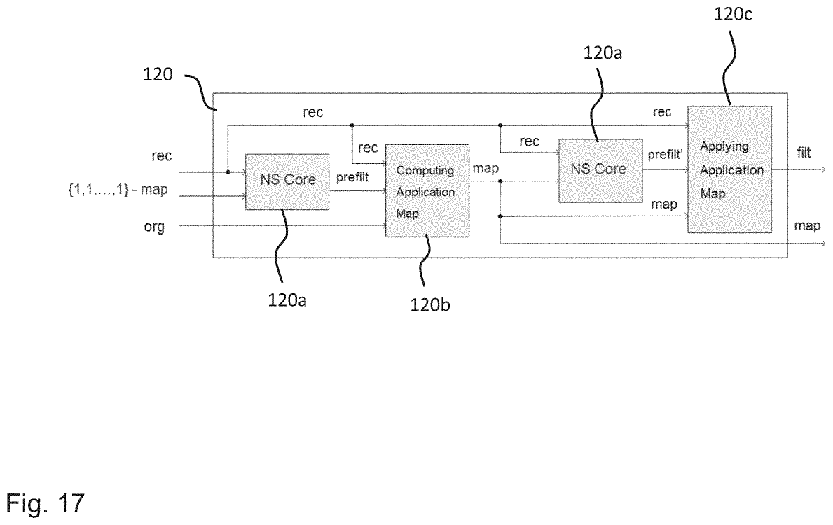

As already described above, the encoder 100 shown in FIG. 1 can comprise the loop filter apparatus 120 according to the above embodiments. FIG. 17 shows an embodiment of the loop filter apparatus 120 of the encoder 100. The loop filter apparatus 120 can comprise the noise suppression unit 120a of FIG. 13 or the noise suppression unit 120a of FIG. 15 as well as a unit 120b for determining the application map and a unit 120c for applying the application map. The loop filter apparatus 120 is configured to receive the reconstructed picture “rec” (or at least a portion thereof), original picture “org” and a dummy or initialization application map “{1, 1, . . . 1}”. As will be appreciated, in the embodiment shown in FIG. 17 the noise suppression unit 120a is called (or implemented) twice for allowing use of the application map in the second call thereof. In the first call of the noise suppression unit 120a a dummy application map can be used, which defines, for example, for all regions of the reconstructed picture that the filtered sample blocks are to be used for generating the filtered reconstructed picture. Further embodiments may use other dummy application maps. The dummy application map may also be referred to as initialization application map. In the second call (or instance) of the noise suppression unit 120a actual application map which was computed in 120b can be used.

Thus, in an embodiment, the processing circuitry of the loop filter apparatus 120 of the encoder 100 is, in a first processing stage, configured to:
apply the first partition to the reconstructed picture or at least a portion thereof for partitioning the reconstructed picture into the plurality of sample blocks;
filter the plurality of sample blocks by applying a respective noise suppression filter to the plurality of sample blocks for obtaining a plurality of filtered sample blocks; and
generate the application map on the basis of the plurality of sample blocks and the plurality of filtered sample blocks using a performance measure, in particular a rate distortion measure; and
wherein in a second processing stage the processing circuitry of the loop filter apparatus 120 of the encoder 100 is configured to:
filter the one or more of the plurality of sample blocks by applying a respective noise suppression filter to the one or more of the plurality of sample blocks for obtaining one or more filtered sample blocks, wherein the one or more of the plurality of sample blocks are defined by the application map generated in the first processing stage and wherein the noise suppression filter depends on the application map, wherein the application map partitions the reconstructed picture into a plurality of regions and defines for each region of the plurality of regions to use at least one of the one or more filtered sample blocks or one or more unfiltered sample blocks of the plurality of sample blocks from the respective region for generating the filtered reconstructed picture; and
generate the filtered reconstructed picture on the basis of the one or more unfiltered sample blocks and the one or more filtered sample blocks.

As already described above, in a further embodiment, the processing circuitry of the loop filter apparatus 120 of the encoder 100 is configured to filter the plurality of sample blocks by applying a respective noise suppression filter to the plurality of sample blocks for obtaining a plurality of filtered sample blocks using a dummy application map, wherein the dummy application map partitions the reconstructed picture into a plurality of regions and defines for each region of the plurality of regions to use at least one of the plurality of filtered sample blocks from the respective region for generating the filtered reconstructed picture.

In an embodiment, the entropy encoding unit 170 of the encoder 100 is configured to encode the application map in the encoded data, i.e. bitstream 303.

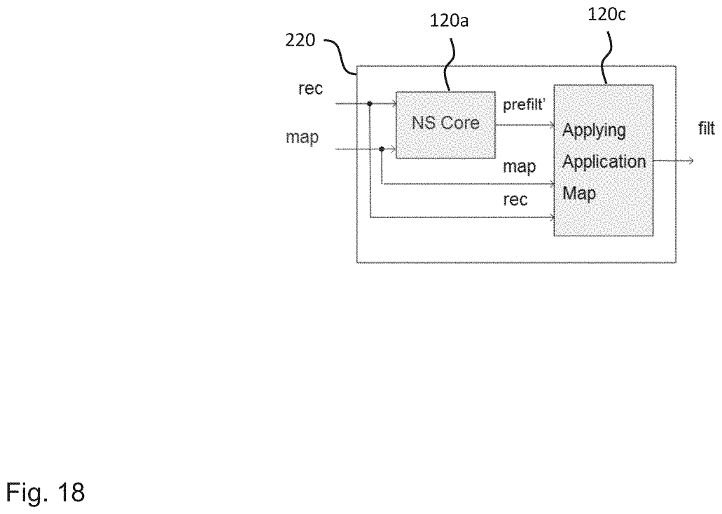

As already described above, the decoder 200 shown in FIG. 2 can comprise the loop filter apparatus 220 according to the above embodiments. FIG. 18 shows an embodiment of the loop filter apparatus 220 of the decoder 200. The loop filter apparatus 220 can comprise the noise suppression unit 120a of FIG. 13 or the noise suppression unit 120a of FIG. 15 as well as the unit 120c for applying the application map. In an embodiment, the decoding unit 204 of the decoder 200 is configured to extract the application map from the encoded video stream 303 provided by the encoder 100. In other words, the loop filter apparatus 220 is configured to receive the reconstructed picture “rec” (or at least a portion thereof), and a received and/or decoded application map “map”.

As already mentioned above, embodiments of the loop filter apparatus 120, 200 are similar to the loop filter apparatus 401 shown in FIG. 4. While the above description has focused on the differences between embodiments of the loop filter apparatus 120, 200 and the loop filter apparatus 401 shown in FIG. 4, the person skilled in the art will appreciate that unless explicitly stated to contrary in other aspects the loop filter apparatus 120, 200 can be identical to the loop filter apparatus 401 shown in FIG. 4 and described above and in great detail in PCT/RU2016/000920, which is herein explicitly incorporated by reference.

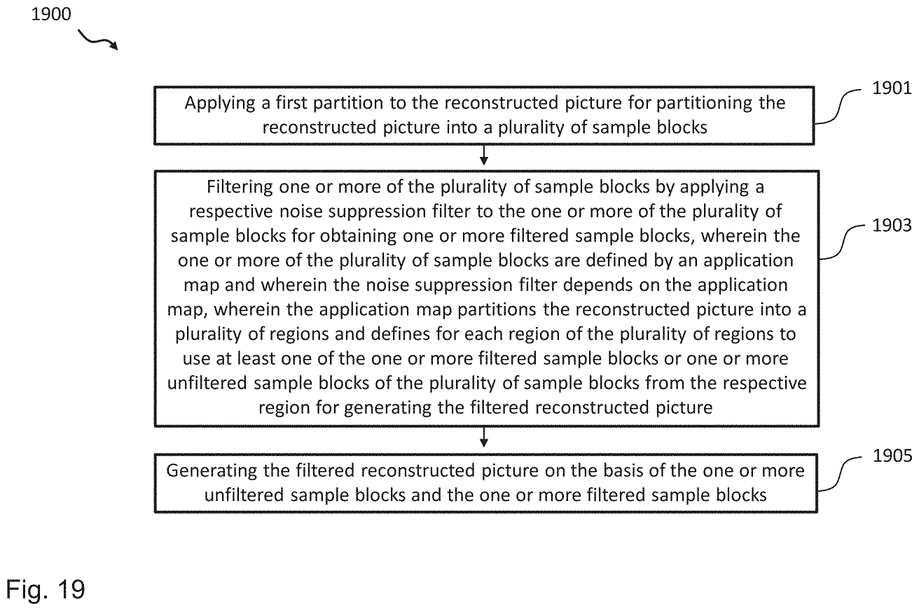

FIG. 19 is a flow diagram showing an example of a loop filtering method 1900 according to an embodiment. The loop filtering method 1900 comprises the steps of:
applying 1901 a first partition to the reconstructed picture or at least a portion thereof for partitioning the reconstructed picture into a plurality of sample blocks;
filtering 1903 one or more of the plurality of sample blocks by applying a respective noise suppression filter to the one or more of the plurality of sample blocks for obtaining one or more filtered sample blocks, wherein the one or more of the plurality of sample blocks are defined by an application map and wherein the noise suppression filter depends on the application map, wherein the application map partitions the reconstructed picture into a plurality of regions and defines for each region of the plurality of regions to use at least one of the one or more filtered sample blocks or one or more unfiltered sample blocks of the plurality of sample blocks from the respective region for generating the filtered reconstructed picture; and
generating 1905 the filtered reconstructed picture on the basis of the one or more unfiltered sample blocks and the one or more filtered sample blocks.

Note that this specification provides explanations for pictures (frames), but fields substitute as pictures in the case of an interlace picture signal.

Although embodiments have been primarily described based on video coding, it should be noted that embodiments of the encoder 100 and decoder 200 (and correspondingly the system 300) may also be configured for still picture processing or coding, i.e. the processing or coding of an individual picture independent of any preceding or consecutive picture as in video coding.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

The terminology of “units” is merely used for illustrative purposes of the functionality of embodiments of the encoder/decoder and are not intended to limiting the disclosure.

In the several embodiments provided in the present application, it should be understood that the disclosed system, apparatus, and method may be implemented in other manners. For example, the described apparatus embodiment is merely exemplary. For example, the unit division is merely logical function division and embodiments may comprise other divisions. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments may be integrated into one processing unit, or each of the units may exist alone physically, or two or more units are integrated into one unit.

Embodiments of the present disclosure may further comprise an apparatus, e.g. encoder and/or decoder, which comprises processing circuitry configured to perform any of the methods and/or processes described herein.

Embodiments of the encoder 100 and/or decoder 200 may be implemented as hardware, firmware, software or any combination thereof. For example, the functionality of the encoder/encoding or decoder/decoding may be performed by processing circuitry with or without firmware or software, e.g. a processor, a microcontroller, a digital signal processor (DSP), a field programmable gate array (FPGA), an application-specific integrated circuit (ASIC), or the like.

The functionality of the encoder 100 (and corresponding encoding method 100) and/or decoder 200 (and corresponding decoding method 200) may be implemented by program instructions stored on a computer readable medium. The program instructions, when executed, cause processing circuitry, computer, processor or the like, to perform the steps of any of the methods described herein, in particular the steps of the encoding and/or decoding methods. The computer readable medium can be any medium, including non-transitory storage media, on which the program is stored such as a Blu ray disc, DVD, CD, USB (flash) drive, hard disc, server storage available via a network, etc.

Embodiments of the present disclosure include or are computer programs comprising program code for performing any of the methods described herein, when executed on a computer.

Embodiments of the present disclosure include or are computer readable media comprising a program code that, when executed by a processor, causes a computer system to perform any of the methods described herein.

1. A loop filter apparatus for processing a reconstructed picture of a video stream, the reconstructed picture including a plurality of samples, the loop filter apparatus comprising:
processing circuitry configured to:
apply a first partition to at least a portion of the reconstructed picture for partitioning the portion of the reconstructed picture into a plurality of sample blocks;
filter one or more of the plurality of sample blocks by applying a respective noise suppression filter to the one or more of the plurality of sample blocks to obtain one or more filtered sample blocks, wherein the one or more of the plurality of sample blocks are defined by an application map, wherein the respective noise suppression filter depends on the application map, wherein the application map partitions at least the portion of the reconstructed picture into a plurality of regions and defines, for each respective region of the plurality of regions, one or more filtered sample blocks or one or more unfiltered sample blocks of the plurality of sample blocks from the respective region to be used for generating the filtered reconstructed picture; and
generate a filtered reconstructed picture based on the one or more unfiltered sample blocks and the one or more filtered sample blocks.

2. The loop filter apparatus of claim 1, wherein the processing circuitry is configured to apply the respective noise suppression filter to a respective current sample block of the one or more of the plurality of sample blocks to obtain the one or more filtered sample blocks by:
determining, based on a similarity measure, one or more further sample blocks similar to the respective current sample block to obtain a respective stack of sample blocks, the respective stack of sample blocks including the current sample block and the one or more further sample blocks;
collectively filtering the respective stack of sample blocks to obtain a respective filtered stack of sample blocks; and
generating the respective current filtered sample block based on the one or more filtered stacks of sample blocks,
wherein the determining the one or more further sample blocks similar to the respective current sample block and/or the collectively filtering the respective stack of sample blocks depends on the application map.

3. The loop filter apparatus of claim 2, wherein a respective stack of sample blocks comprises one or more overlapping sample blocks.

4. The loop filter apparatus of claim 2, wherein the processing circuitry is configured to generate the respective current filtered sample block based on the one or more filtered stacks of sample blocks by averaging the sample blocks of the one or more filtered stacks of sample blocks, which at least partially overlap the current sample block.

5. The loop filter apparatus of claim 2, wherein the processing circuitry is configured to determine, based on the similarity measure, the one or more further sample blocks similar to the respective current sample block to obtain a respective stack of sample blocks by using the application map,
wherein the processing circuitry is configured to determine the one or more further sample blocks similar to the respective current sample block using sample blocks from those regions of the plurality of regions, defined by the application map, where the one or more filtered sample blocks are to be used for generating the filtered reconstructed picture.

6. The loop filter apparatus of claim 2, wherein the processing circuitry is configured to determine the one or more further sample blocks similar to the respective current sample block by determining, based on the similarity measure for each of the one or more further sample blocks, a similarity measure value and by comparing the similarity measure value with a threshold value.

7. The loop filter apparatus of claim 2, wherein the processing circuitry is configured to collectively filter the respective stack of sample blocks to obtain the respective filtered stack of sample blocks based on the application map by collectively filtering those sample blocks, of the respective stack of sample blocks, from regions of the plurality of regions defined by the application map where the one or more filtered sample blocks are to be used for generating the filtered reconstructed picture.

8. The loop filter apparatus of claim 1, wherein each region of the plurality of regions defined by the application map comprises at least one of the one or more sample blocks.

9. A video encoding apparatus for encoding a picture of a video stream, comprising:
a reconstruction engine configured to reconstruct the picture; and
a loop filter apparatus according to claim 1 for processing the reconstructed picture.

10. The video encoding apparatus of claim 9, wherein the processing circuitry of the loop filter apparatus is configured to perform, in a first processing stage:
the applying the first partition to at least the portion of the reconstructed picture for partitioning the portion of the reconstructed picture into the plurality of sample blocks;
filtering the plurality of sample blocks by applying the respective noise suppression filter to the plurality of sample blocks to obtain a plurality of filtered sample blocks; and
generating the application map based on the plurality of sample blocks and the plurality of filtered sample blocks using a a rate distortion measure; and
wherein the processing circuitry of the loop filter apparatus is configured to perform, in a second processing stage:
the filtering the one or more of the plurality of sample blocks by applying the respective noise suppression filter to the one or more of the plurality of sample blocks to obtain the one or more filtered sample blocks; and
the generating the filtered reconstructed picture based on the one or more unfiltered sample blocks and the one or more filtered sample blocks.

11. The video encoding apparatus of claim 10, wherein the processing circuitry of the loop filter apparatus is further configured to perform, in the first processing stage:
filtering the plurality of sample blocks by applying the respective noise suppression filter to the plurality of sample blocks to obtain the plurality of filtered sample blocks by using a dummy application map, wherein the dummy application map partitions the reconstructed picture into a plurality of dummy regions and defines, for each respective dummy region of the plurality of dummy regions, filtered sample blocks from the respective dummy region to be used for generating the filtered reconstructed picture.

12. The video encoding apparatus of claim 9, wherein the video encoding apparatus further comprises an encoder configured to encode the application map in an encoded video stream.

13. A video decoding apparatus for decoding a picture of an encoded video stream, wherein the video decoding apparatus comprises:
a reconstruction engine configured to reconstruct the picture; and
a loop filter apparatus according to claim 1 for processing the reconstructed picture.

14. The video decoding apparatus of claim 13, wherein the video decoding apparatus further comprises a decoder configured to decode the application map using the encoded video stream.

15. A loop filtering method for processing a reconstructed picture of a video stream, the reconstructed picture including a plurality of samples, the loop filtering method comprising:
applying a first partition to at least a portion of the reconstructed picture for partitioning the portion of the reconstructed picture into a plurality of sample blocks;
filtering one or more of the plurality of sample blocks by applying a respective noise suppression filter to the one or more of the plurality of sample blocks to obtain one or more filtered sample blocks, wherein the one or more of the plurality of sample blocks are defined by an application map, wherein the noise suppression filter depends on the application map, wherein the application map partitions at least the portion of the reconstructed picture into a plurality of regions and defines, for each respective region of the plurality of regions, one or more filtered sample blocks or one or more unfiltered sample blocks of the plurality of sample blocks from the respective region to be used for generating the filtered reconstructed picture; and
generating a filtered reconstructed picture on the basis of the one or more unfiltered sample blocks and the one or more filtered sample blocks.

16. A computer program product comprising program code that includes processor-executable instructions for performing the method of claim 15.
